(19) United States
(12) Patent Application Publication
(10) Pub. No.: US 2002/0046240 A1
(43) Pub. Date: Apr. 18, 2002

(54) Web server framework

(76) Inventors: Scott Graham, Independence, KY (US); Michael Grady, Cincinnati, OH (US); Stephen Weagraff, Orlando, FL (US); Michael Sauer, Cleves, OH (US); Rahul Jindal, Longwood, FL (US)

Correspondence Address: STANDLEY & GILCREST LLP, 495 METRO PLACE SOUTH, SUITE 210, DUBLIN, OH, 43017, US

(21) Appl. No.: 09/943,136

(22) Filed: Aug. 29, 2001

Related U.S. Application Data
(60) Provisional application No. 60/229,450, filed on Aug. 31, 2000.

(51) Int. Cl. G06F 15/16

(52) U.S. Cl. 709/203

(57) ABSTRACT

The present invention is directed toward a framework for consistent and minimized development of Web-based applications. A preferred Web-based application of the present invention is built on a web server framework utilizing industry standard technologies relating to Web development and deployment. These technologies fall into three main areas: browser technology, Web server technology, and application server technology. A preferred Web architecture of the present invention is preferably based on HTTP, utilizing a browser, Middleware, and a Web Server, the Web Server comprising Java servlets, Java Server Pages, Java Beans, and a Web Server Framework. This architecture follows a standard Model, View, Controller pattern. Preferably, the initial servlet is the Controller, the Java Beans are the Model, and the JSP is the View. Preferred frameworks include an Error Framework, a Logging and Tracing Framework, a Connection Framework, a Reference Data Framework, a Security Framework, and an International Framework.

This application claims the benefit of Provisional Application Ser. No. 60/229,450 filed Aug. 31, 2001, which is incorporated herein by reference.

### BACKGROUND AND SUMMARY OF THE INVENTION

The present invention relates generally to Web-based applications. Specifically, this invention relates to a Web Server Framework for consistently handling Web-based applications.

Traditionally, different Web-based applications have required separate systems to handle user requests. For instance, each application would need to develop separate code to handle security and user validation. This not only increased the time needed to develop these applications, but also resulted in different applications even within the same company handling tasks in many different ways.

It is therefore an object of the present invention to develop a framework for Web-based applications that allows separate applications to be developed in a common and consistent way that requires a minimal amount of development time.

The present invention comprises a Web server framework for browser-based applications utilizing an application server. The framework uses a Command Servlet to receive an HTTP request from a user's browser. An Application Controller then receives information from the Command Servlet in response to the HTTP request, the Application Controller adapted to communicate with and receive data from the application server. The Application Controller then creates at least one Java Bean to handle the HTTP request, the Java Bean also adapted to communicate with and receive data from the application server. The Java Bean passes control back to the Command Servlet upon receiving the data from the application server needed to handle the request. A Java Server Page then receives a call from the Command Servlet. The Java Server Page attaches HTML to any dynamic data represented in the Java Bean and formats a response to be output to the browser. A Compiler receives the HTML and dynamic data from the Java Server Page and compiles them into a Java servlet. The Java Servlet is adapted to be run directly by the Web Server in response to a similar future HTTP request, doing away with any need to generate subsequent Java Beans or compile Java code while the Java servlet remains valid.

Preferred web server frameworks include an error framework, a logging and tracing framework, a connection framework, a reference data framework, a security framework, and an international framework. An error framework is preferably adapted to provide a common base for application-specific Java exceptions. It may also provide language-specific formatting of error messages.

A logging and tracing framework preferably provides a common method of logging messages and events. A logging and tracing framework is preferably also adapted to format log messages for subsequent interpretation and provide at least two levels of logging, each level allowing differing amounts of data capture.

A connection framework preferably provides a common method of establishing pools of connections to other resources. The pools may be any appropriate pools, such as JDBC, MQ-Series, and CORBA Pools. A connection framework may also be adapted to allow applications built on the framework to define characteristics of these pools.

A reference data framework preferably provides a mechanism for applications built on the framework to store common lists of data in memory for efficient access. A reference data framework may also provide a mechanism for Java Server Pages to build choice lists from these data lists.

A security framework preferably provides a common model for applications to maintain security information available to applications built on the framework. A security framework may integrate with other frameworks to provide the frameworks with security information. A security framework may also allow applications built on the framework to check security on any object type.

An international framework preferably provides a set of objects that are country-dependant. Such objects may include address, currency, name, and phone number objects. An international framework may provide formatting routines that may be modified by applications built on the framework. An international framework may provide methods for displaying or gathering data for these objects.

Also included in the present invention is a method for operating a web-based application. In the method, a Command Servlet receives an HTTP request from a Web browser. At least one Java Bean is created to handle the HTTP request, the creation determined by the Command Servlet. The Java Bean is adapted to communicate with and receive data from an application server. At least one Java Server Page is created to receive a call from the Command Servlet, attach HTML to any dynamic data represented in the Java Bean, and format an output response for the Web browser in response to the HTTP request. The HTML and dynamic data received from the Java Server Page are then compiled into a Java Servlet. The Java Servlet is adapted to be run directly in response to a similar future HTTP request such that there is no need to generate similar Java Beans or Compile similar Java code while the servlet remains valid. The formatted response is then sent to the Web browser.

In addition to the novel features and advantages mentioned above, other objects and advantages of the present invention will be readily apparent from the following descriptions of the drawings and preferred embodiments.

### BRIEF DESCRIPTION OF THE DRAWINGS

FIG. 1 is a diagram of a Web-based application system in accordance with one embodiment of the present invention.

FIG. 2 is a diagram of the application flow in accordance with one embodiment of the present invention.

FIG. 3 is a diagram showing the preferred components of a Web Server Framework in accordance with one embodiment of the present invention.

FIG. 4 is a flow diagram of a Web Server in accordance with one embodiment of the present invention.

FIG. 5 is a screen shot of an application built on a Web Server Framework of the present invention.

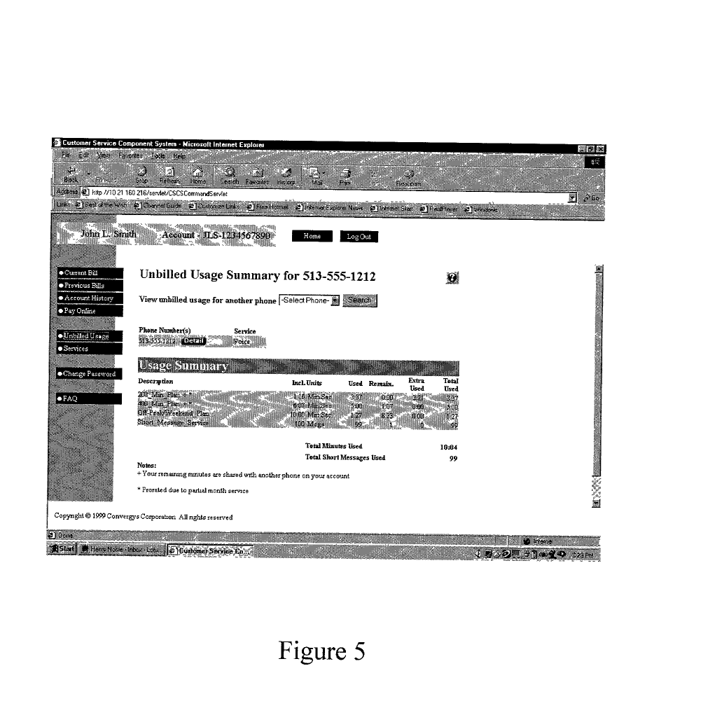

### DETAILED DESCRIPTION OF PREFERRED EMBODIMENT(S)

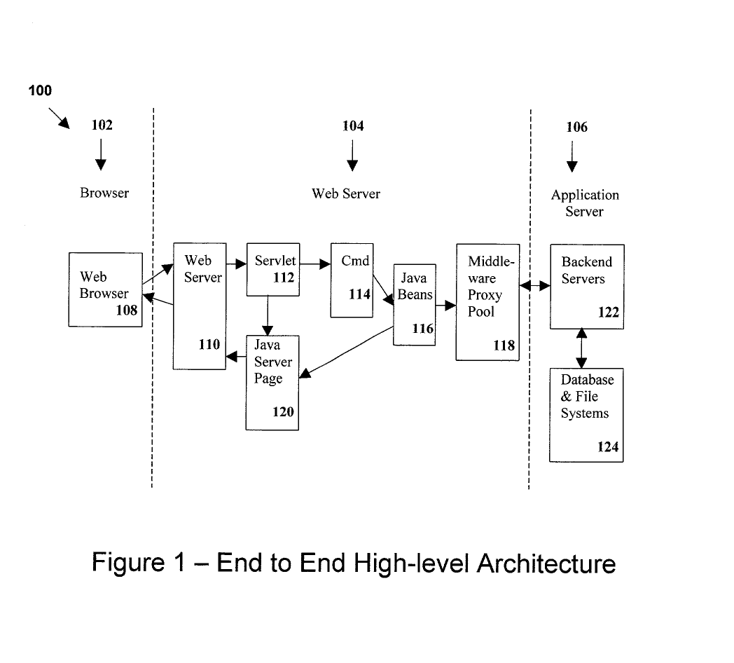

The present invention is directed toward a framework for Web-based applications. Although the example given of the preferred embodiment is directed toward a framework for applications in the billing industry, it should be appreciated that such a framework may be useful in any industry or situation for which multiple Web-based applications are built and maintained. A preferred Web-based application of the present invention is built utilizing industry standard technologies relating to Web development and deployment. These technologies fall into three main areas: browser technology, Web server technology, and application server technology. FIG. 1 shows a diagram of these technologies.

FIG. 1 breaks down a web-based application 100 into browser 102, web server 104, and application server 106 components. The browser component 102 comprises a web browser 108, typically a commercial browser such as Microsoft Internet Explorer or Netscape Navigator on a remote user's computer, or a customized browser at an internal company location. The browser preferably provides general presentation services, such as the formatting of pages sent back from the Web server 104. This preferably occurs using standard HTTP protocol.

Looking to the Web server component 104, the Web server 110 is adapted to receive a request from the Web browser 108 and process the request. Processing is preferably performed using Java-based technologies, although other similar technologies now known or subsequently developed may be used for said processing. In a preferred method of processing, the request is first received by a Java servlet 112. As used herein, a Java servlet 112 is a small Java program similar to a CGI program. The Web server 110 preferably operates a Java Virtual Machine to process these servlets, although other processing applications may be appropriate. As the Web browser 102 requests a Java servlet 112, a servlet engine in the Web server 110 preferably verifies that the servlet is not out of date. If the servlet is out of date, it is then preferably reloaded. The servlet engine preferably also maintains a session cache to track user information between requests. The Web server 110 preferably keeps track of these sessions and removes them after a period of inactivity.

The Web Server Framework of the present invention augments this process by adopting a Command Pattern to simplify the development of the response/reply cycle. Control is passed from the Java servlet 112 to the Command 114. The command 114 then interacts with specific Java Beans 116, each Java Bean 116 representing a particular business object. The beans 116 often need to communicate with the Application Server component 106, particularly business logic servers in the backend. These business logic servers will be referred to herein as Backend Servers 122. This communication preferably occurs via a CORBA-based messaging service or other middleware. The Backend Servers 122 preferably access the necessary data from the Application Server Database and File Systems 124, then send appropriate replies to the appropriate Java Bean 116. To improve performance, Connection or Middleware Proxy Pools 118 may be used to multiplex requests over a smaller number of connections. When the Java Bean 116 receives the reply, it passes control back to the Command 114. The Command 114 then determines the next page to display to the user via the Web Browser 108. This is preferably done via a call to a Java Server Page (JSP) 120.

The Java Server Pages 120 are preferably used to attach HTML to dynamic data represented in the Java Beans 116. The Pages preferably separate the dynamic data content from the static HTML content. This has many advantages, the first of which is in the area of skill separation. HTML developers may concentrate on presentation, while Java Bean/Servlet developers may be able to concentrate on application flow and data assembly, while backend developers may concentrate on enforcing business rules. A second advantage is the ability to customize the HTML content or presentation of pages via standard HTML editing tools. This may be done by an authorized user or Web Site Administrator without effecting the logical behavior of the application.

It is preferred that the JSP technology be kept relatively simple, such as by embedding JSP tags the HTML. A JSP Page Compiler preferably pre-compiles the HTML and JSP tags to generate Java code. A Java compiler then preferably compiles this Java code to produce a Java servlet 112. This translation and compilation preferably occurs only the first time that a page is visited. Thereafter, it is preferred that the Web Server 110 simply run the servlet 112. This process greatly improves the speed and efficiency of the Java Server Pages.

The JSP tags preferably represent Java Beans or business objects, often requiring access to the Backend Server's business logic. This is preferably done via the Middleware Proxy Pool 118 in order to get the appropriate data from the Database and File Systems 124. The JSP Page Compiler and Java compiler may be components that accompany the JSP technology, such as BEA Web Logic or IBM's Web Sphere products.

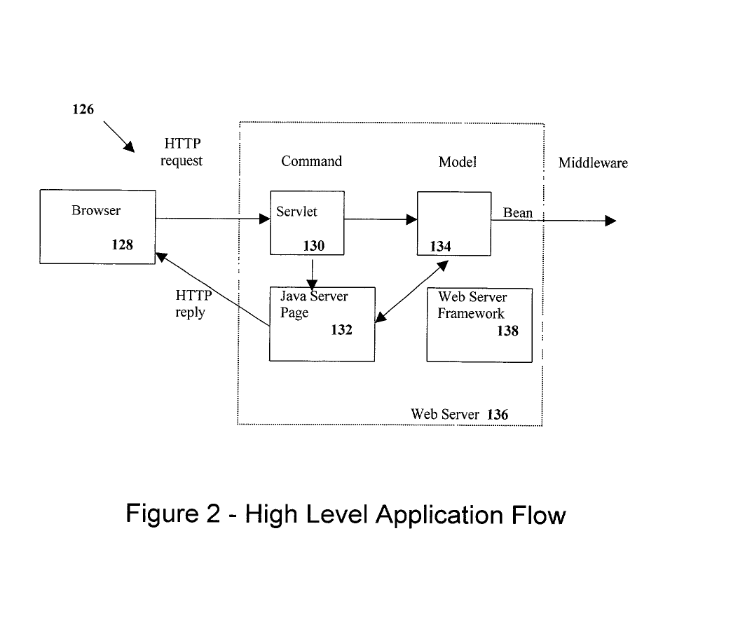

FIG. 2 shows a preferred Web architecture 126 of the present invention. As stated previously, this architecture is preferably based on HTTP, utilizing a browser 128, middleware, and a Web Server 136, the Web Server comprising Java servlets 130, Java Server Pages 132, Java Beans 134, and the aforementioned Web Server Framework 138. This architecture follows a standard Model, View, Controller pattern. Preferably, the initial servlet is the Controller, the Java Beans are the Model, and the JSP is the View. This provides for a clean separation of the View from the Model.

The preferred purpose of the Web Server Framework (WSF) is to provide a single infrastructure and methodology to address security, internationalization, state management, multi-window tasks, servlet multi-threading, and to connect to various middleware platforms. A preferred WSF may reduce the work required by Web server application developers. The WSF may be available to all application developers, preferably including the following components: Command Servlet, Security, Connection Proxy Pool, Reference Data Controller, Internationalization, Error Handling, and Logging and Tracing. The Command Servlet is preferably the foundation of the WSF. The other components may be used to support the Command Servlet and other aspects of Web server development.

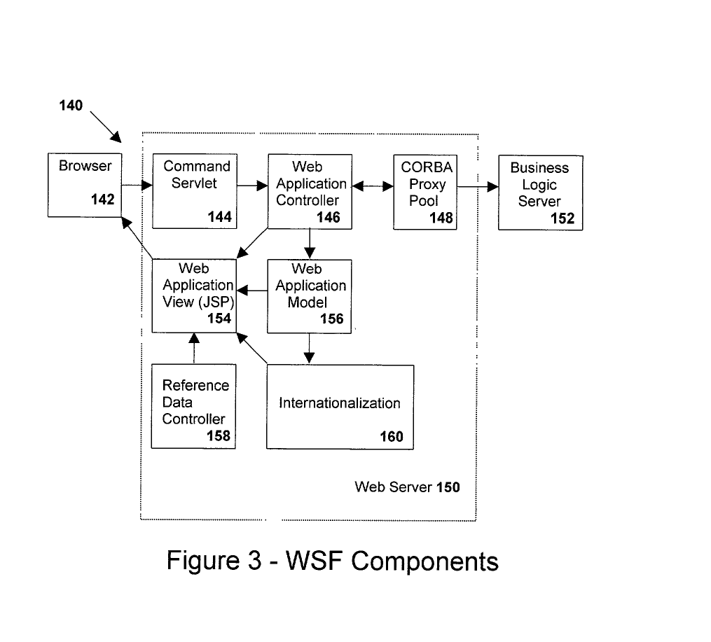

FIG. 3 shows an overview of a preferred Web Server Framework Architecture 140. First, the Command Servlet component 144 takes information from the browser 142 and passes it to the Web Application Controller 146 of the Web Server 150. The Web Application Controller 146 then uses a Connection Proxy Pool 148 to retrieve information from the Business Logic Server 152. The Web Application Controller 146 then creates the appropriate Java Beans in the Web Application Model 156. The Web Application Controller 146 preferably places the Java Beans in the session or request and calls the next JSP 154. The JSP then uses the Java Beans and reference data, with help from the Reference Data Controller 158 and Internationalization component 160, to format the output for the Browser 142.

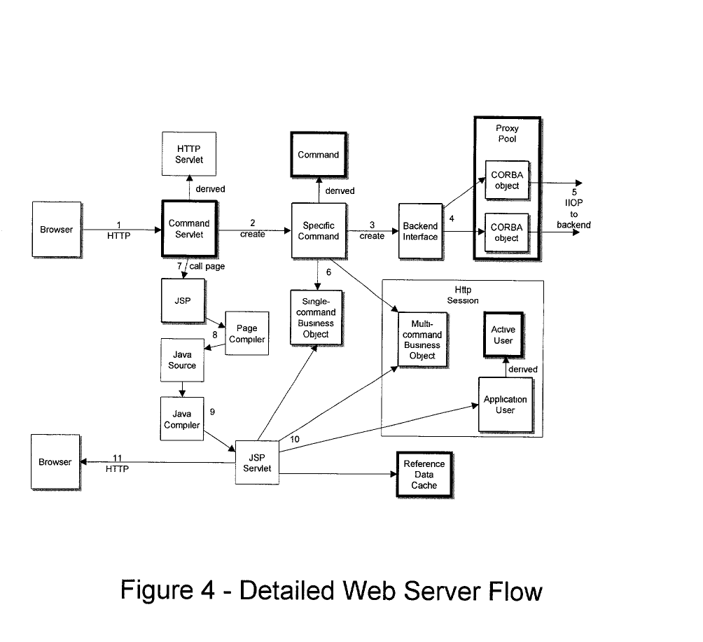

FIG. 4 shows a detailed diagram of the preferred Web Server Flow. An HTTP request is sent to the Command Servlet via a “post” or “get” from the Browser, typically as a result of a user choosing a URL link or selecting a button such as “Submit” button. The HTML Web page author preferably sets the HTML form action or link reference to point to an appropriate servlet and passes the command in an appropriate parameter. The HTTP request is then preferably sent to a Servlet derived from a Java Servlet class HTTP Servlet. This Command Servlet preferably executes a doPost, doGet, or similar method as a result of the user request.

The doPost and doGet methods preferably call a common Perform Command method. The Perform Command method extracts a command class property from the HTTP request, instantiates an object of the specified class, passes the request to the command and calls an Execute method on the command. The application command class specified in a command class preferably inherits from the WSF class command and implements an Abstract Method Execute.

If an application command must pass a security check, it preferably inherits from a WSF Class Secure command and implements an abstract method. In this case, a Secure Command preferably inherits from Command and implements the Execute method. The Execute method preferably insures that an Active User Object has been instantiated and placed in the session. It preferably also verifies that the active user has been authenticated and that the user has authority to execute the command.

Once inside the application command's Execute or Execute Secured methods, the framework provides several Convenience methods supplied by the WSF. Preferred methods to be included are addToRequest, getLocale, getSessionAttribute, removeSessionAttribute, setNextPage, setPropertiesFromRequest, and set SessionAttribute.

The add ToRequest(key,object) method preferably places the specified object into the request identified by key. This allows objects to be placed into the request for later use by the JSP. The request is preferably used instead of the session whenever possible so that the life span of the objects is not longer than the time needed for construction of the next page.

The getLocale( ) method preferably uses a predefined algorithm to determine a user's current locale. The method preferably first looks for an Active User Object in the session that has already defined a locale. If no such object is found, the method looks in the request for a parameter such as “localeString.” If this parameter is found, the method preferably looks in the browser settings. If this is not successful, the method preferably returns the default locale for the Web server.

The getSessionAttribute(key) method preferably returns the object identified by key that has previously been placed in the session.

The removeSessionAffribute(key) method preferably removes the object identified by key that has previously been placed in the session. This is preferably called on all attributes that are in the session and are no longer needed.

The setNextPage(pageLocator) method preferably informs the WSF which page should next be shown to the user. The pageLocator parameter is preferably built by passing a logical page name and resource bundle name such that the WSF can apply the user's locale to the resource bundle and get the physical name of the next page. There is preferably also a convenience method setNextPage(logicalName,, bundleName) for the above command.

The setPropertiesFromRequest( ) method preferably attempts to match all parameters passed in on the request to properties on the command. For example, if a parameter with the name “Address” is passed in on the request, this method will preferably take the value of the parameter and attempt to pass it to a setaddress method specified on the command.

The setSessionAttribute(key, object) method preferably places the object identified by key into the user's session. This object preferably remains in the session until the object is later removed by an appropriate call or the session is timed out by the Web server.

The application command then preferably initiates a call to the backend to perform a business function. It is preferred that the application use a Domain Firewall to isolate the command from having to know the backend and structure of the application model. The application command preferably creates a Domain Firewall object to gather the data from the backend. The Domain Firewall object preferably implements an interface for each application model object that it creates. The application command then preferably creates each object that it passes to the JSP and passes the Domain Firewall object to construct the model object.

After the data has been retrieved from the backend, the application command preferably creates the appropriate application model objects and places them either in the request or the session.

The request is a preferred storage location for objects being passed to the JSP for memory management reasons. Objects placed in the request preferably live only from the time they are created until the JSP is displayed. They may then be available to the Java Virtual Machine for garbage collection. If an object is placed in the session, that object preferably lives until a later command removes it from the session or the session is timed out by the Web server.

The Command preferably determines the next logical page to display by retrieving a Page Locator object set in the application command. It then uses the application command's locale to determine which physical page to display based on the logical page settings in the Page Locator.

The physical Java Server Page file, preferably containing HTML with imbedded JSP tags, is passed to the runtime JSP compiler component of the Web server. The JSP compiler preferably converts the HTML and JSP tags into Java source code. The Java source code may then be compiled by the Java Compiler on the Web server and a Java servlet created. The Java Servlet may now use the application model Java Beans that have been placed in the request and/or session by the application command object. Data stored in the Reference Data Cache may also be used by the servlet.

The new page generated by the Java Servlet incorporating the data provided by the application model beans and Reference Data Cache is then preferably displayed on the user's browser. The page may be represented using standard HTML transmitted over HTTP or HTTPS protocol.

The Web Server Framework preferably supplies a framework relating to security. The Security Framework preferably provides a common model for applications to maintain security information that is to be available to web applications. The Security Framework preferably integrates with the Command Frameworks to provide the necessary security information, and may allow applications to check security on any type of object in an application. Fundamentally, this framework encompasses three types of security services: authentication, authorization, and fabrication. Within the framework, authentication involves the steps required to validate a user of the application. Authorization is preferably a process in which a command from a user is checked to validate that the user has the correct privileges to perform the command.

Authentication is preferably required by parts of the Web Server Framework. The framework may provide an abstract class to be supplemented by the application for use in authenticating a user. An Active User class preferably specifies an abstract method for application-specific instances to respond to the framework in ensuring that a user has been authenticated. It is preferably the responsibility of the application classes to gather information such as user ID and password, and to actually authenticate the user. The application-specific object derived from Active User is preferably placed by the application's login command into the session.

On subsequent calls, a Secured Command class in the framework may be used to verify that a user has been authenticated prior to calling the application command, since a user can request any URL via a browser. Each request is preferably checked such that a user is not able navigate to any page without having first logged in. In addition, the Web server preferably destroys idle sessions after a period of inactivity, invalidating the login. All this enforcement is preferably done via the Secured Command. An application programmer may only need to create commands requiring authentication derived from the Secured Command.

The second security service is Authorization. Authorization is a preferred service to allow access to resources, such as commands or pages, based on a user's identity. Again, the abstract class Active User is preferably used to gather authorization information during login. The Active User class preferably specifies an abstract method that is passed appropriate parameters, such as an integer resource type and a string resource name. The application-specific instances of Active User preferably provide this method in order to respond to the framework, ensuring that a user has been authorized to access the specified resource. The application classes are preferably responsible for interpreting the meaning of the parameters passed and responding with a non-zero return code.

On each call, the Secured Command class in the framework preferably verifies that a user has been authorized to execute the requested application command by passing a Secured Resource Command and the command class name to a Get Authorization Method. This is preferably done via the Secured Command. Access to pages and other resources may be checked in a similar manner.

Fabrication preferably involves changing the application on a user's role. Java code may be executed to dynamically alter a page based on the active user's role, usually via a JSP scriptlet. The active user is first queried to determine whether the user has access to a secured resource. If access is allowed, specific HTML is preferably emitted.

A Connection Framework is preferably used to provide a common way of establishing pools of connections to other resources. A set of pre-defined pools may include JDBC, MQ-Series, or CORBA pools. A preferred Connection Framework also allows applications to define the characteristics of the pools. A Connection Framework may utilize a Connection Manager class that contains an object representing the connection manager resources. The connection manager preferably maintains a list of connections. An application requests an object from the Connection Manager by calling a Get Connection method of the Connection Manager object, indicating which type of object is required. The Get Connection method then preferably returns a Connection that in this case is actually a CORBA Connection Object. The application then preferably asks the Connection for the contained object by calling its GetConnectionObject method. Once all processing is complete, a Release method may be called on the Connection Object to make the resource available for other threads. These objects may implement a Connection Factory Interface supplied by the WSF that requires them to implement a Get Connection method.

In addition to a Connection Factory implementation, the application preferably adds properties to a Connection Manager File. Since the WSF Proxy pool is preferably built on an IBM Connection Manager or other similar application, many of the properties in this file may be required for the IBM Connection Manager to work properly.

A Reference Data Framework is preferably used to provide a mechanism for applications to store common lists of data in memory. This process allows the data lists to be accessed more efficiently. The Reference Data Framework preferably also provides a mechanism for Java Server Pages to build choice lists from these stored data lists. As an example, a Reference Data Controller may be used to allow an application to cache reference data to be used in building drop-down lists for display on a Web page. A Reference Data Cache object preferably controls the list of reference data tables. The list preferably contains logical tables, each logical table pointing to physical tables made up of List Item objects. A logical table is preferably the locale-independent representation of the physical table, the physical table being the locale-specific version. The application preferably creates the list of tables to be loaded into the cache.

A preferred way to load a Reference Data Cache is for an application to create a servlet, the servlet intended to be loaded when the Web server boots, establishes, and loads the cache in an initialize method. The method Get Instance may be used to create a reference to the Reference Data Cache object. If the cache needs to be locale dependent, the servlet may call a Set Resource Bundle method to a resource bundle for the Reference Data Cache to use in mapping logical table names to physical table names. If a logical table or resource bundle does not exist, it may be assumed that the logical table name matches the physical table name.

A servlet may then use two preferred methods to load the cache, Load Table From File and Add Item To Table. The Load Table From File method preferably creates a physical table in the cache by loading data from a delimited or similar file. The Add Item To Table method preferably adds a List Item to a physical table. If the table does not exist, it may be created. If a call needs to be made to a backend server to get data for the cache, it may also create List Item objects from the backend data and use an Add Item To Table method to add the List Items to the cache.

In order for a Java Server Page to display a drop-down list from a reference data table, it may need to create a Select Item Adapter Object. Once this object is created, a Make List Items method may be called with a logical table name, the code of the item to be initially selected, a flag indicating a value needs to be chosen, and the locale. This method then preferably returns a string containing the HTML required to build the values in the list.

Another preferred framework of the present invention is an International Framework, providing the ability to internationalize applications. The International Framework provides a set of objects that vary from country to country but not language to language like the International features of the Java language. Such objects may include address, currency, name, and phone number. The International Framework preferably provides methods for displaying these objects, methods for gathering data for these objects, and formatting routines that may be modified by applications.

There are several characteristics of an internationalized application. The addition of localized data allows the same application to be run worldwide. Text elements, such as status messages and user interface labels, need not be hard-coded into the program. Supporting new languages does not require a recompilation of existing application code. Culturally dependent data such as dates and currencies or addresses and phone numbers appears in a format that conforms to an end user's region and language. If done properly, the performance of the application is not compromised. A preferred International Framework supports all these application characteristics. The Java platform preferably provides two mechanisms to create internationalized software. The first of these is the Locale class, which represents a specific geographical, political, or cultural region. The second internationalization feature is the use of Resource Bundles.

An operation that requires a Locale to perform its task will be called locale-sensitive, using the Locale to tailor information for the user. For example, displaying a number is a locale-sensitive operation since the number should be formatted according to the customs/conventions of a user's native country, region, or culture. A locale is preferably identified by three components. The first component is specified using a two-character lower case ISO Language Code defined by ISO-639. The second component is specified using a two-character upper case ISO Country Code defined by ISO-3166. The third component is application defined and has traditionally been used to identify locales that have converted to the use of the EURO currency. Separating the three components, such as by using an underscore character, may be used to represent locales. For example, a string representation for English spoken in the United States may be “en_US”, English spoken in Canada “en_CA”, and so forth.

Resource bundles preferably contain locale-specific objects. When a program needs a locale-specific resource, such as a string to be displayed to the end user, the program may load it from the resource bundle appropriate for that specific locale. A resource bundle may be defined as a set of related classes that inherit from a Java Utility Resource Bundle. Each related subclass may have the same base name, along with an additional component identifying its locale. For example, if a resource bundle is named MyResources, the first class likely to be written is the default resource bundle simply having the same name as its family, MyResources. As many related locale-specific classes as needed may then be provided, such as a German class named MyResources_de. Each related subclass preferably contains the same items, but the items have been translated for the locale represented by that subclass.

If there are different languages for a country, specific resource bundle classes may be created for each language, such as MyResources_de_CH and MyResources_fr_CH for Switzerland. It is possible to only modify some of the resources in the specialization. The resource bundle class preferably associates a parent to any bundle. If an object value cannot be found in the specified subclass, a Resource Bundle function may search the parent class in the relationship. This relationship may be established among bundles by giving them the same base name.

The application preferably obtains the appropriate bundle using a static Get Bundle Method having two arguments: bundleName and Locale. The first argument preferably specifies the family name of the resource bundle containing the object in question. The second argument preferably indicates the desired locale. The Get Bundle Method preferably uses these two arguments to construct the name of the Resource Bundle subclass it should load. First, the resource bundle lookup searches for classes with a named formed by the joining of the family name with the various components of the locale, from more specific to less specific, as follows:

1. baseclass+“_”+language1+“_”+country1+“_”+variant1

2. baseclass+“_”+language1+“_”+country1

3. baseclass+“_”+language1

4. baseclass

If the resource bundle still cannot be found, the same search algorithm may be utilized, this time substituting the default locale for the specified locale:

1. baseclass+“_”+language2+_+country2+_+variant2 (for default locale)

2. baseclass+“_”+language2+“_”+country2 (for default locale)

3. baseclass+“_”+language2 (for default locale)

As an example, if the default locale determined from the operating system is en_US (U.S. English), but it is desired to load MyResource for the fr_CA (Canadian French) locale instead, the call to ResourceBundle.GetBundle(“MyResource”, new Locale(“fr”,“CA”)) would preferably produce the following search order:

1. MyResource_fr_CA

2. MyResource_fr

3. MyResource

4. MyResource_en_US

5. MyResource_en

The search preferably ends as soon as the resource bundle is found. If the resource bundle is not found, the Get Bundle method may throw a Missing Resource Exception. The baseclass may also need to be fully qualified. It is preferably also accessible by the code rather than in a class that is private to the package from which the Get Bundle method is called.

Resource bundles typically contain key/value pairs. The keys are preferably unique in identifying locale-specific objects in a bundle, and are preferably Strings. In general, a value may be any type of object. The values are preferably obtained by calling a Get Object method with a String argument, identifying the key of the value to be returned. There may also be a Get String method for convenience to save having to cast the result to a String if the type of value to be returned is known.

The JDK preferably provides two subclasses of Resource Bundle: a List Resource Bundle and a Property Resource Bundle. These preferred bundles provide a fairly simple way to create resources. The purpose of a List Resource Bundle is to allow the definition of localizable elements as a two-dimensional array of key/value pairs. This bundle is easy to use and requires only minimal code, allowing focus to shift to providing data in the bundle.

A Property Resource Bundle may be the easiest bundle to implement, as it preferably involves creating only a text file. A Property Resource Bundle may have multiple lines, each line having a text or other appropriate entry such as a comment, blank line, or <key>=<value>entry. Property bundles preferably follow the same naming conventions as those used by a List Resource Bundle. Property bundles, however, are not compiled and preferably have a “properties” or other appropriate extension.

The preferred approach to internationalizing the presentation of the user interface is to create separate JSP files for each locale. The application command preferably identifies the next page by passing a logical page name and resource bundle family name to a Set Next Page routine. The resource bundle family may then be accessed using the logical page name to obtain the actual URL of the JSP file. Only URLs that are different than the default resource bundle may need to be specified in the locale-specific resource bundles. The URLs for the remaining logical page names are preferably found in a top-level resource bundle.

In order to create a new localization, a new properties file may need to be created. A preferred naming convention for this file involves the use of the name <Ww>_<xx>_<YY> properties, where <Ww>is the resource bundle family name, <xx> is the ISO two letter language code, and <YY> is the ISO two letter country code for the new locale. If a set of shared resources is being created for a language without a country, just the language suffix may be used without the_<YY>. An example resource bundle name would be ApplicationJSPBundle_pt_BR.properties for Portuguese as spoken in Brazil, and ApplicationJSPBundle_pt.properties for generic Portuguese. The file may contain entries such as:

LoginPage=servlet/Login_pt_BR.jsp

Bill Page=servlet/Bill_pt_BR.jsp

To translate an English Java Server Page to another language, the HTML within the JSP file may simply be translated from English. The contents of the JSP may simply be pasted in a window provided at such a site. The translated output may then be pasted into a new file JSP file, the name specified in the properties file.

Formatting Beans are preferably used to format dynamic page content for dates and numbers according to the locale of the current user. The JDK Formatting Beans may include Data Format and Number Format Beans, which may be used within the JSP to provide locale-specific formatting. An Active User Bean, which is preferably available through the session, may be used to obtain the appropriate locale. Within the JSP, a formatting bean preferably takes as input the locale and the data to be displayed, producing a string formatted according to the locale. The following is an example using a Date Format Bean:

DateFormat df=DateFormat.getDatel instance(activeUser.getLocale());

out.Printin(“The date is ”+df.format(myDate));

A Message Formatter is an object that is preferably used to format a compound message, one that consists of both static and variable text. Unlike simple messages, compound messages may not be stored directly in Resource Bundles. Resource Bundles may, however, be used indirectly to provide a solution. Each variable text item may be replaced by an argument providing a message formatter. The resulting combination of static text and arguments, known as a message pattern, may then be placed in a Resource Bundle. In the application program, a Message Format Object may be created with the pattern obtained from the resource bundle, the appropriate arguments, and the locale to produce the formatted message. All literal strings are preferably stored in resource bundles.

A String class Compare To method may fail to properly alphabetize different languages. To compensate, the JDK preferably provides a Collator Class that is able to compare strings in a language-independent manner.

The Web Server Framework preferably supplies additional classes to support concepts that are not locale-specific based on a user's characteristics, but are locale-specific based on the data represented. This may include such items as addresses, phone numbers, names and currencies. All classes described below preferably work in a similar manner to the Formatter Beans discussed above.

An Address Class and associated Address Format Class preferably work together to provide address formatting to Web applications. The Address object preferably contains fields for country, delivery text, city, region, postal code primary, postal code secondary, attention and name. Since the formatting of an address may be dependent on country field, convenience methods may be provided to perform basic formatting and provide access to the Address Format Object associated with the Address.

The Address Format Object preferably provides methods for returning a multi-line address and an individual address line. A method may also be provided to return the number of lines in a formatted address, or to assist in data entry. A method may determine how many input fields exist for a given address, or properly order the presentation of data entry fields. The latter method preferably returns the field constants identifying each field.

A Phone Number Class and associated Phone Number Format Class preferably work together to provide phone number formatting to Web applications. The Phone Number object may contain fields for country code, area code, switching number, line number and extension. Since the formatting of a phone number is dependent on country code, convenience methods may be provided to perform basic formatting, and to provide access to the associate Phone Number Format object. The Phone Number Format Object preferably provides methods for returning a formatted phone number.

A Person Name Class and associated Person Name Format Class preferably work together to provide name formatting to Web applications. The Person Name object may contain fields for prefix, first name, middle name, last name, generation, degree and suffix. The Person Name Format Object preferably provides methods for returning a formatted name, and methods for identifying the proper instance of a Person Name Format Object based on country, address, or locale.

A Currency Class and associated Currency Format Class preferably work together to provide currency formatting to Web applications. The Currency object may contain fields for amount and locale. Convenience methods may be provided for formatting that utilizes standard JDK Number Format Objects. Methods are preferably also provided for converting between Euros and base currencies for countries that have converted to the Euro standard. The conversion rates for these countries may be fixed at the point of conversion. As new countries convert to the Euro standard, resource bundles may be updated to contain the conversion factors.

An Error Framework is preferably used as a common base for applicationspecific Java exceptions. The framework may automatically integrate with a Logging and Tracing Framework to log error events, and preferably provides languagespecific formatting of error messages. An Error Framework preferably offers several classes to be used for error processing and exception handling. An Exception Class preferably provides a basic framework for creating language independent error messages. Other classes may expand the Exception Class to provide standard logging of error messages to the application log and the system log respectively. The framework to allow JSPs to access error messages in a standard way preferably also supplies an Error Bean. Exceptions may be stored inside a locale-aware Error Bean Object so that they may be displayed to the end user.

The Exception Class is preferably an abstract class that allows developers to create their own exceptions. Language independence is gained by using property resource bundles containing message format text. The Exception Class preferably maintains an array of strings containing message substitution variables. Application specific exceptions may gather variable data via named parameters, passing them on to the Exception Class using generic constructors. The application exceptions may also provide implementations of abstract methods, pointing to the resource bundle to get static message text and uniquely identifying the message within the bundle. The Exception Class preferably also provides a convenience constructor to pass a string, or an array of strings, to be used as a substitution variable.

An Error Bean preferably provides a common method for Java Server Pages to format error messages produced by the application. If an error occurs, the application preferably places an Error Bean in the request. The Error Bean may have constructors that can be passed a string, a Java exception, or an Exception and locale. If the third constructor is called, the error message created may be specific to the locale passed. A JSP may call an appropriate method on the Error Bean to determine if an error has been raised. If there is an error, the JSP may call a Get Error Message method that will return the message text associated with the error indicated by the Error Bean.

Another preferred framework, a Logging and Tracing Framework, preferably provides a common way to log messages and events. The Framework preferably formats log messages for interpretation by performance measurement software. The Logging and Tracing Framework preferably also provides different levels of logging to allow differing amounts of data capture.

A Logging and Tracing Framework preferably utilizes two objects to perform logging and tracing. The first object, the Error Log Object, may be used by the WSF to send messages to the Web server error log. The second object is the Event Log Object. It preferably provides several methods for sending messages to the Web server event log. A Log Event Method may also be used for logging other miscellaneous events. These methods are preferably passed the current object and a string value indicating an event to be logged.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A web server framework for browser-based applications utilizing an application server, said web server framework comprising:
(a) a Command Servlet adapted to receive an HTTP request from said browser;
(b) an Application Controller adapted to receive information from said Command Servlet in response to said HTTP request, said Application Controller adapted to communicate with and receive data from said application server;
(c) at least one Java Bean created by said Application Controller to handle said HTTP request, said Java Bean adapted to communicate with and receive data from said application server, said Java Bean adapted to pass control back to said Command Servlet upon receiving said data;
(d) at least one Java Server Page, said Java Server Page adapted to receive a call from said Command Servlet after said Command Servlet regains control from said Java Bean, said Java Server Page adapted to attach HTML to any dynamic data represented in said Java Bean and format the output for said browser in response to said HTTP request; and
(e) at least one Compiler adapted to receive said HTML and said dynamic data from said Java Server Page and compile said HTML and said dynamic data into a Java servlet, said Java Servlet adapted to be run directly by said Web Server in response to a similar future said HTTP request.

2. A web server framework according to claim 1 additionally comprising a Java Virtual Machine adapted to process said Java Servlet.

3. A web server framework according to claim 1 additionally comprising a session cache maintained by said Web Server adapted to track user information between said HTTP requests.

4. A web server framework according to claim 1 wherein said Java Bean represents a business object.

5. A web server framework according to claim 1 wherein the said communication with said application server is accomplished by an application selected from the group consisting of CORBA-based messaging services and middleware.

6. A web server framework according to claim 1 additionally comprising at least one Proxy Pool adapted to multiplex said communications with said application server.

7. A web server framework according to claim 1 wherein said application server is a Backend Logic Server.

8. A web server framework according to claim 1 additionally comprising at least one external database in communication with said application server, said external database adapted to house said requested data.

9. A web server framework according to claim 1 additionally comprising a domain firewall adapted to isolate said Command Servlet from said application server.

10. A web server framework according to claim 1 wherein said Java Servlet is adapted to handle related to requests selected from the group consisting of Security, Data Control, Internationalization, State Management, Multi-Window Tasks, Servlet Multi-Threading, Middleware Connection, Error Handling, Logging, and Tracing.

11. A web server framework according to claim 1 wherein said web server framework is an error framework.

12. A web server framework according to claim 11 wherein said error framework is adapted to provide a common base for application-specific Java exceptions.

13. A web server framework according to claim 11 wherein said error framework is adapted to provide language-specific formatting of error messages.

14. A web server framework according to claim 1 wherein said web server framework is a logging and tracing framework.

15. A web server framework according to claim 14 wherein said logging and tracing framework is adapted to provide a common method of logging messages and events.

16. A web server framework according to claim 14 wherein said logging and tracing framework is adapted to format log messages for subsequent interpretation.

17. A web server framework according to claim 14 wherein said logging and tracing framework is adapted to provide at least two levels of logging, each said level allowing differing amounts of data capture.

18. A web server framework according to claim 1 wherein said web server framework is a connection framework.

19. A web server framework according to claim 18 wherein said connection framework is adapted to provide a common method of establishing pools of connections to other resources.

20. A web server framework according to claim 19 wherein said pools are selected from the group consisting of JDBC, MQ-Series, and CORBA Pools.

21. A web server framework according to claim 19 wherein said connection framework is adapted to allow applications built on said framework to define characteristics of said pools.

22. A web server framework according to claim 1 wherein said web server framework is a reference data framework.

23. A web server framework according to claim 22 wherein said reference data framework is adapted to provide a mechanism for applications built on said framework to store common lists of data in memory for efficient access by said applications.

24. A web server framework according to claim 23 wherein said reference data framework is adapted to provide a mechanism for Java Server Pages to build choice lists from said data lists.

25. A web server framework according to claim 1 wherein said web server framework is a security framework.

26. A web server framework according to claim 25 wherein said security framework is adapted to provide a common model for applications to maintain security information available to applications built on said framework.

27. A web server framework according to claim 25 wherein said security framework is adapted to integrate with other said frameworks to provide the frameworks with security information.

28. A web server framework according to claim 25 wherein said security framework is adapted to allow applications built on said framework to check security on any object type.

29. A web server framework according to claim 1 wherein said web server framework is an international framework.

30. A web server framework according to claim 29 wherein said international framework is adapted to provide a set of objects that are country-dependant.

31. A web server framework according to claim 30 wherein said objects are selected from the group consisting of address, currency, name, and phone number objects.

32. A web server framework according to claim 29 wherein said international framework is adapted to provide formatting routines that may be modified by applications built on said framework.

33. A web server framework according to claim 30 wherein said international framework is adapted to provide methods for displaying said objects.

34. A web server framework according to claim 30 wherein said international framework is adapted to provide methods for gathering data for said objects.

35. A system for operating web-based applications, said system comprising:
(a) an Web browser, said Web browser adapted to generate and receive information via HTTP;
(b) an application server, said application server adapted to run business logic and access data necessary for said web-based applications; and
(c) a Web server in communication with said Web browser and said application server, said Web server comprising at least one web server framework, said web server framework comprising:
(i) a Command Servlet adapted to receive an HTTP request from said Web browser;
(ii) an Application Controller adapted to receive information from said Command Servlet in response to said HTTP request, said Application Controller adapted to communicate with and receive data from said application server;
(iii) at least one Java Bean created by said Application Controller to handle said HTTP request, said Java Bean adapted to communicate with and receive data from said application server, said Java Bean adapted to pass control back to said Command Servlet upon receiving said data;
(iv) at least one Java Server Page, said Java Server Page adapted to receive a call from said Command Servlet after said Command Servlet regains control from said Java Bean, said Java Server Page adapted to attach HTML to any dynamic data represented in said Java Bean and format the output for said Web browser in response to said HTTP request; and
(v) at least one Compiler adapted to receive said HTML and said dynamic data from said Java Server Page and compile said HTML and said dynamic data into a Java servlet, said Java Servlet adapted to be run directly by said Web Server in response to a similar future said HTTP request.

36. A system for operating web-based applications according to claim 35 additionally comprising a Java Virtual Machine adapted to process said Java Servlet.

37. A system for operating web-based applications according to claim 35 additionally comprising a session cache maintained by said Web Server adapted to track user information between said HTTP requests.

38. A system for operating web-based applications according to claim 35 wherein said Java Bean represents a business object.

39. A system for operating web-based applications according to claim 35 wherein the said communication with said application server is accomplished by an application selected from the group consisting of CORBA-based messaging services and middleware.

40. A system for operating web-based applications according to claim 35 additionally comprising at least one Proxy Pool adapted to multiplex said communications with said application server.

41. A system for operating web-based applications according to claim 35 wherein said application server is a Backend Logic Server.

42. A system for operating web-based applications according to claim 35 additionally comprising at least one external database in communication with said application server, said external database adapted to house said requested data.

43. A system for operating web-based applications according to claim 35 additionally comprising a domain firewall adapted to isolate said Command Servlet from said application server.

44. A system for operating web-based applications according to claim 35 wherein said Java Servlet is adapted to handle related to requests selected from the group consisting of Security, Data Control, Internationalization, State Management, Multi-Window Tasks, Servlet Multi-Threading, Middleware Connection, Error Handling, Logging, and Tracing.

45. A web server framework according to claim 35 wherein said web server framework is an error framework.

46. A web server framework according to claim 46 wherein said error framework is adapted to provide a common base for application-specific Java exceptions.

47. A web server framework according to claim 46 wherein said error framework is adapted to provide language-specific formatting of error messages.

48. A web server framework according to claim 35 wherein said web server framework is a logging and tracing framework.

49. A web server framework according to claim 48 wherein said logging and tracing framework is adapted to provide a common method of logging messages and events.

50. A web server framework according to claim 48 wherein said logging and tracing framework is adapted to format log messages for subsequent interpretation.

51. A web server framework according to claim 48 wherein said logging and tracing framework is adapted to provide at least two levels of logging, each said level allowing differing amounts of data capture.

52. A web server framework according to claim 35 wherein said web server framework is a connection framework.

53. A web server framework according to claim 52 wherein said connection framework is adapted to provide a common method of establishing pools of connections to other resources.

54. A web server framework according to claim 53 wherein said pools are selected from the group consisting of JDBC, MQ-Series, and CORBA Pools.

55. A web server framework according to claim 53 wherein said connection framework is adapted to allow applications built on said framework to define characteristics of said pools.

56. A web server framework according to claim 35 wherein said web server framework is a reference data framework.

57. A web server framework according to claim 56 wherein said reference data framework is adapted to provide a mechanism for applications built on said framework to store common lists of data in memory for efficient access by said applications.

58. A web server framework according to claim 56 wherein said reference data framework is adapted to provide a mechanism for Java Server Pages to build choice lists from said data lists.

59. A web server framework according to claim 35 wherein said web server framework is a security framework.

60. A web server framework according to claim 59 wherein said security framework is adapted to provide a common model for applications to maintain security information available to applications built on said framework.

61. A web server framework according to claim 59 wherein said security framework is adapted to integrate with other said frameworks to provide the frameworks with security information.

62. A web server framework according to claim 59 wherein said security framework is adapted to allow applications built on said framework to check security on any object type.

63. A web server framework according to claim 35 wherein said web server framework is an international framework.

64. A web server framework according to claim 63 wherein said international framework is adapted to provide a set of objects that are country-dependant.

65. A web server framework according to claim 64 wherein said objects are selected from the group consisting of address, currency, name, and phone number objects.

66. A web server framework according to claim 63 wherein said international framework is adapted to provide formatting routines that may be modified by applications built on said framework.

67. A web server framework according to claim 64 wherein said international framework is adapted to provide methods for displaying said objects.

68. A web server framework according to claim 64 wherein said international framework is adapted to provide methods for gathering data for said objects.

69. A method for operating a web-based application, said method comprising the steps of:
(a) receiving an HTTP request from a Web browser to a Command Servlet;
(b) creating at least one Java Bean to handle said HTTP request, said creation determined by said Command Servlet, said Java Bean adapted to communicate with and receive data from an application server;
(c) creating at least one Java Server Page adapted to receive a call from said Command Servlet, attach HTML to any dynamic data represented in said Java Bean, and format an output response for said Web browser in response to said HTTP request;
(d) compiling said HTML and said dynamic data received from said Java Server Page into a Java Servlet, said Java Servlet adapted to be run directly in response to a similar future HTTP request; and
(e) sending said formatted response to said Web browser.

70. A method for operating a web-based application according to claim 69 additionally comprising the step of processing said Java Servlet with a Java Virtual Machine.

71. A method for operating a web-based application according to claim 69 additionally comprising the step of generating and maintaining a session cache to track user information between said HTTP requests.

72. A method for operating a web-based application according to claim 69 additionally comprising the step of multiplexing said communications with said application server.
